(19) United States
(12) Patent Application Publication
(10) Pub. No.: US 2014/0250741 A1
(43) Pub. Date: Sep. 11, 2014

(54) Rooted plant removal equipment and method of use

(71) Applicant: Fred Simmons, Amarillo, TX (US)

(72) Inventor: Fred Simmons, Amarillo, TX (US)

(21) Appl. No.: 14/198,588

(22) Filed: Mar. 5, 2014

Related U.S. Application Data
(60) Provisional application No. 61/773,136, filed on Mar. 5, 2013.

(51) Int. Cl. A01G 23/06

(52) U.S. Cl. CPC A01G 23/065
USPC 37/302

(57) ABSTRACT

A digging tool is disclosed. Said digging tool comprising a blade and a frame. Said frame attaches to a two arms of an articulating arm utility vehicle. Said blade comprises a top side, a bottom side, a first side edge, a second side edge, a back side having a point, a front side having a v-cut portion. Said blade is mounted on said frame and used as a digging tool with said v-cut portion by: pressing said blade with said v-cut portion into a ground surface, grabbing a portion of a target object beneath said ground surface with said v-cut portion, pulling a portion of said target object above said ground surface

This application is a nonprovisional application claiming priority to an earlier filed provisional application (U.S. Patent Provisional Application No. 61/773,136) owned having the same applicant and inventor as this application.

### BACKGROUND

This disclosure relates generally to a rooted plant removal equipment and method of use. None of the known prior art or previous applications are seen to describe the currently claimed apparatus and method of use.

### SUMMARY

A digging tool is disclosed. Said digging tool comprising a blade and a frame. Said frame attaches to a two arms of an articulating arm utility vehicle. Said blade comprises a top side, a bottom side, a first side edge, a second side edge, a back side having a point, a front side having a v-cut portion. Said blade is mounted on said frame and used as a digging tool with said v-cut portion by: pressing said blade with said v-cut portion into a ground surface, grabbing a portion of a target object beneath said ground surface with said v-cut portion, pulling a portion of said target object above said ground surface

### BRIEF DESCRIPTION OF THE DRAWINGS

FIG. 1 illustrates a perspective overview of a digging tool attached with an adapter top a skid loader.

FIGS. 2A and 2B illustrate an elevated front view and an elevated top view of said skid loader.

FIGS. 3A, 3B, 3C and 3D illustrate a perspective rear overview, an elevated top view, an elevated first side view and an elevated front view of said digging tool.

FIGS. 4A and 4B illustrate an elevated top and side view of said second horizontal support.

FIGS. 5A, 5B and 5C illustrate an elevated top view, an elevated side view and a perspective rear overview of said blade.

FIGS. 6A, 6B and 6C illustrate a perspective overview, an elevated front view and an elevated side view of a body portion of said digging tool.

FIGS. 7A, 7B and 7C illustrate a perspective overview, an elevated front view and a perspective side view of said first adjustable box adapter.

FIG. 7D illustrates an elevated front view of said digging tool.

FIGS. 8A, 8B and 8C illustrate a perspective overview, an elevated front view and an elevated side view of said adapter.

FIGS. 9A and 9B illustrate a perspective overview of said digging tool 100 attaching to said adapter and attached to said adapter, respectively.

FIGS. 10A, 10B and 10C illustrate a front perspective overview and two elevated cross-section rear views of said digging tool attached to said adapter.

FIG. 10B illustrates said one or more locking assemblies in an unlocked configuration and FIG. 10C illustrates said one or more locking assemblies in a locked configuration.

FIG. 11 illustrates an elevated front view of said digging tool attached to said adapter in said locked configuration.

FIGS. 12A, 12B and 12C illustrate a perspective overview of said digging tool digging up a plant.

FIG. 12A illustrates said skid loader approaching said plant.

FIG. 12B illustrates said skid loader lowering said digging tool over said plant.

FIG. 12C illustrates said digging tool digging up said plant.

### DETAILED DESCRIPTION

Described herein is a rooted plant removal equipment and method of use. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

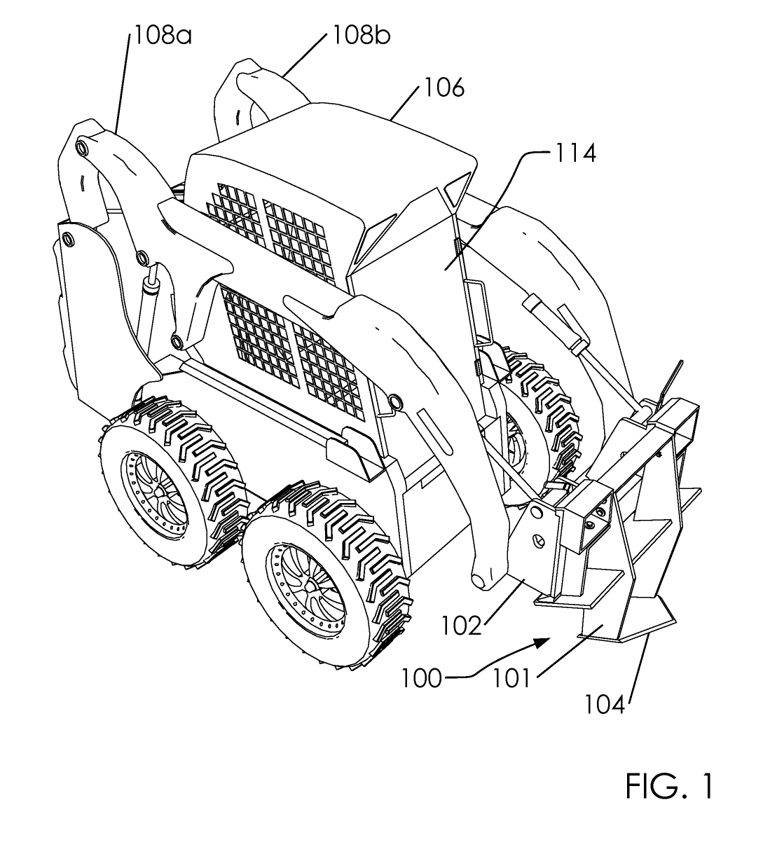

FIG. 1 illustrates a perspective overview of a digging tool 100 attached with an adapter 102 top a skid loader 106. In one embodiment, said skid loader 106 can comprise any among a class of articulating arm utility vehicle. In one embodiment, said digging tool 100 can comprise a frame 101 and a blade 104. In one embodiment, said skid loader 106 can comprise a two arms comprising a first loader arm 108a and a second loader arm 108b. In one embodiment, said adapter 102 can attach said digging tool 100 to said skid loader 106. In one embodiment, said skid loader 106 can use said digging tool 100 to dig items out of the ground. In one embodiment, said two arms can lift and press said digging tool 100 relative to the ground. In one embodiment, said skid loader 106 can comprise a door 114.

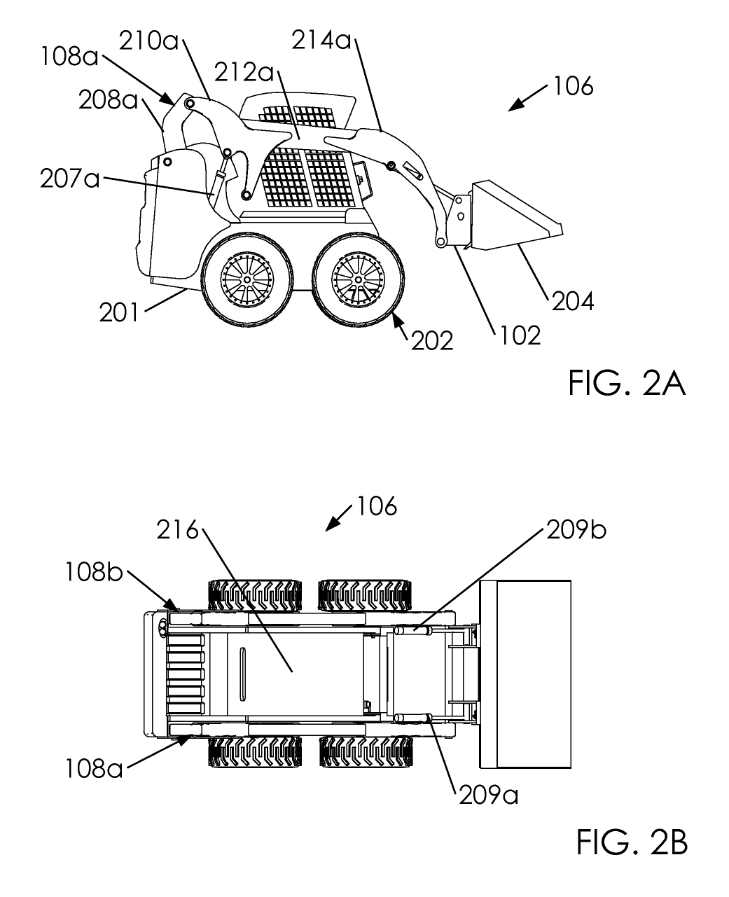

FIGS. 2A and 2B illustrate an elevated front view and an elevated top view of said skid loader 106. In one embodiment, said skid loader 106 can comprise a chassis 201, a four wheels 202, a bucket 204, a one or more front loader arm lift cylinders (comprising a front loader arm lift cylinder 209a and a front loader arm lift cylinder 209b), an operator's compartment 216, and said two arms. In one embodiment, said two arms can comprise one or more segments used to articulate said two arms; for example, said first loader arm 108a can comprise a first segment 208a, a second segment 210a, a third segment 212a, a fourth segment 214a, each attached to one another with one or more pivot joints. In one embodiment, said two arms can be moved by a one or more lift cylinders; for example, said first loader arm 108a can comprise a rear loader arm lift cylinder 207a and said front loader arm lift cylinder 209a, and said loader arms 108 can comprise a rear loader arm lift cylinder 207b and said front loader arm lift cylinder 209b. In one embodiment, said digging tool 100 can attach to a wide variety of vehicles, not just said skid loader 106 (as illustrated). It would be obvious to one in the art that said digging tool 100 could attach to other vehicles such as trucks, backhoes, or similar. Thus, by illustrating said skid loader 106 with said two arms each having one or more segments, it is implied that said digging tool 100 can attach to other vehicles without extensive experimentation.

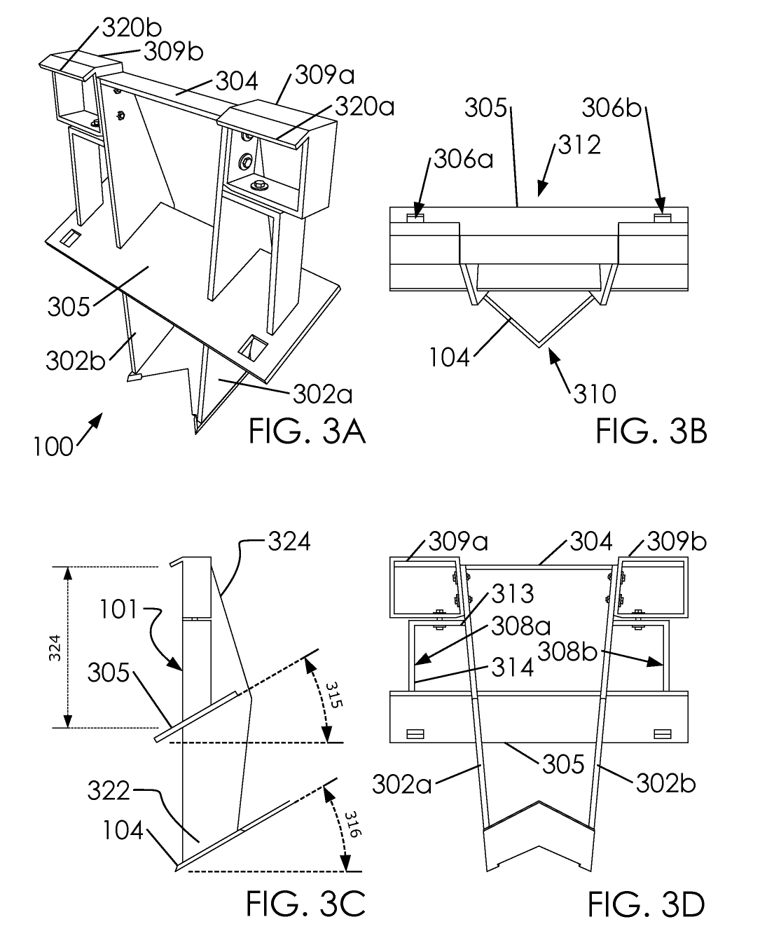

FIGS. 3A, 3B, 3C and 3D illustrate a perspective rear overview, an elevated top view, an elevated first side view and an elevated front view of said digging tool 100. In one embodiment, said frame 101 can comprise a one or more vertical supports (comprising a first vertical support 302a, a second vertical support 302b, an upper portion 324 and a lower portion 322), a one or more horizontal supports (which can comprise a first horizontal support 304 and a second horizontal support 305), a one or more pin apertures (which can comprise a first pin aperture 306a and a second pin aperture 306b), a one or more outer supports (comprising a first outer support 308a and a second outer support 308b), a one or more adjustable box adapters (comprising a first adjustable box adapter 309a and a second adjustable box adapter 309b), a one or more lip supports (comprising a first lip support 320a and a second lip support 320b), a front side 310 and a back side 312. In one embodiment, said one or more horizontal supports can attach to said one or more vertical supports. In one embodiment, said blade 104 can attach at a lower portion of said one or more vertical supports; said first horizontal support 304 can attach at an upper portion of said one or more vertical supports; and said second horizontal support 305 can attach to a mid-portion of said one or more vertical supports. In one embodiment, said one or more outer supports can each comprise a first end 313 and a second end 314; wherein, said one or more outer supports can attach outside of said one or more vertical supports at said first end 313 and to said second horizontal support 305 at said second end 314. In one embodiment, second horizontal support 305 can attach to said one or more vertical supports at an first angle 315 relative to horizontal (as illustrated), and said blade 104 can attach to said one or more vertical supports at an second angle 316 relative to horizontal (as illustrated). In one embodiment, said first angle 315 can be equal to said second angle 316. Thus, in one embodiment said second horizontal support 305 and said blade 104 can be in the same plane. In one embodiment, said one or more apertures can be cut into said second horizontal support 305. In one embodiment, said one or more apertures can be useful for attaching said adapter 102 to said digging tool 100, as is discussed below. In one embodiment, said one or more lip supports can be a portion of said one or more adjustable box adapters. Said digging tool 100 can comprise an attaching distance 324 vertically between said one or more lip supports and said one or more pin apertures.

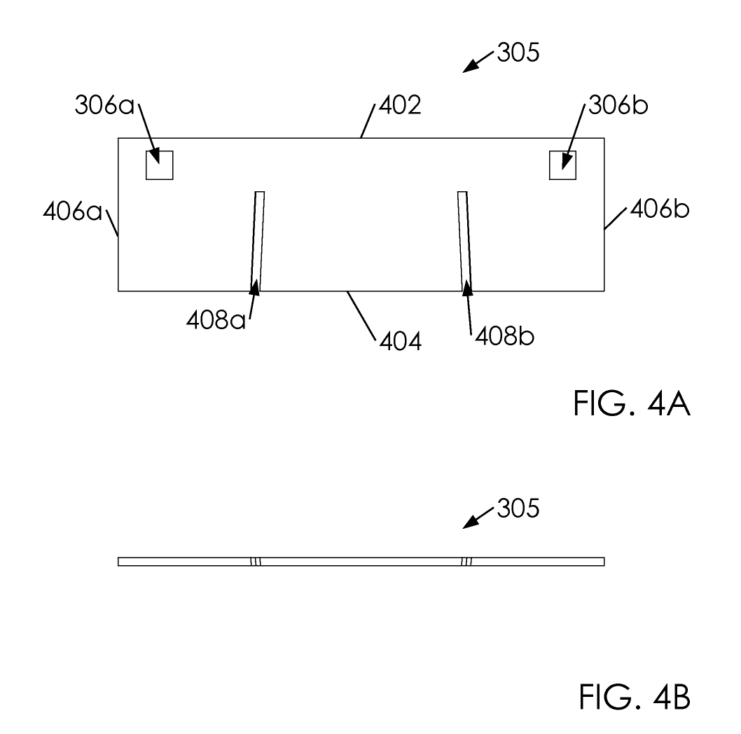

FIGS. 4A and 4B illustrate an elevated top and side view of said second horizontal support 305. In one embodiment, said second horizontal support 305 can comprise a front edge 402, a second edge 404, a first side 406a, a second side 406b, and a one or more slots (comprising a first slot 408a and second slot 408b). In one embodiment, said one or more slots can attach around a portion of said one or more vertical supports. In one embodiment, said second horizontal support 305 can be welded to a portion of said one or more vertical supports. In one embodiment, said one or more slots are in said second edge 404 of said second horizontal support 305. In one embodiment, said one or more apertures can be cut into said second horizontal support 305 near said front edge 402 at said first side 406a and said second side 406b.

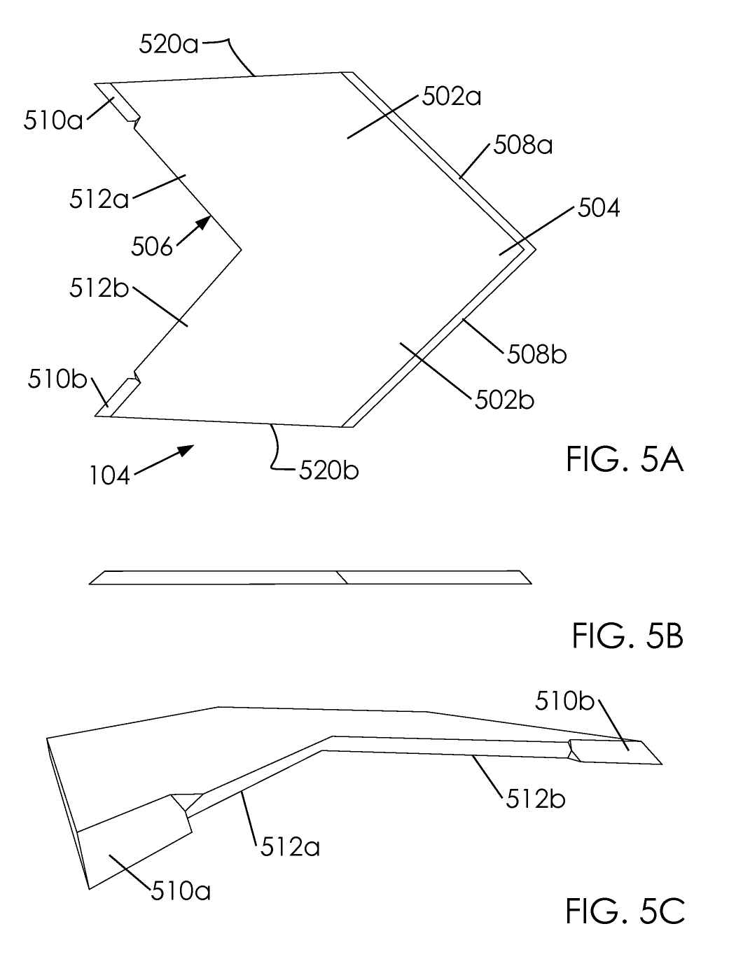

FIGS. 5A, 5B and 5C illustrate an elevated top view, an elevated side view and a perspective rear overview of said blade 104. In one embodiment, said blade 104 can comprise a one or more sides. In one embodiment, said one or more sides can comprise a first side 502a and a bottom side 502b. In one embodiment, said blade 104 can comprise a point 504, a v-cut portion 506, a one or more front bevels, a one or more exterior rear bevels, and a one or more interior rear bevels. In one embodiment, said one or more front bevels can comprise a first front bevel 508a and a second front bevel 508b. In one embodiment, said one or more exterior rear bevels can comprise a first exterior rear bevel 510a and a second exterior rear bevel 510b. In one embodiment, said one or more interior rear bevels can comprise a first interior rear bevel 512a and a second interior rear bevel 512b. In one embodiment, said blade 104 can comprise a first side edge 520a and a second side edge 520b.

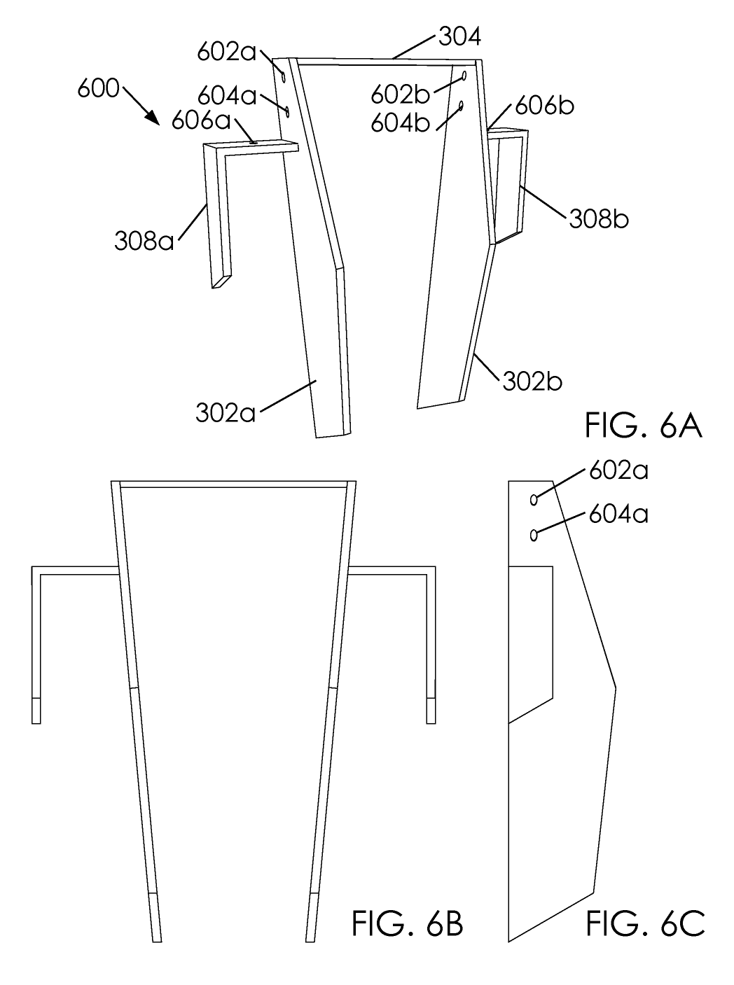

FIGS. 6A, 6B and 6C illustrate a perspective overview, an elevated front view and an elevated side view of a body portion 600 of said digging tool 100. In one embodiment, said body portion 600 can comprise said one or more vertical supports, said first horizontal support 304, and said one or more outer supports of said digging tool 100. In one embodiment, said body portion 600 can comprise a plurality of apertures capable of attaching to said second adjustable box adapter 309b (as described below). In one embodiment, said plurality of apertures can comprise a first aperture 602a and a second aperture 604a in said first vertical support 302a, a third aperture 606a in said first outer support 308a, a second aperture 602b and a second aperture 604b in said second vertical support 302a, and a third aperture 606b in said second outer support 308a.

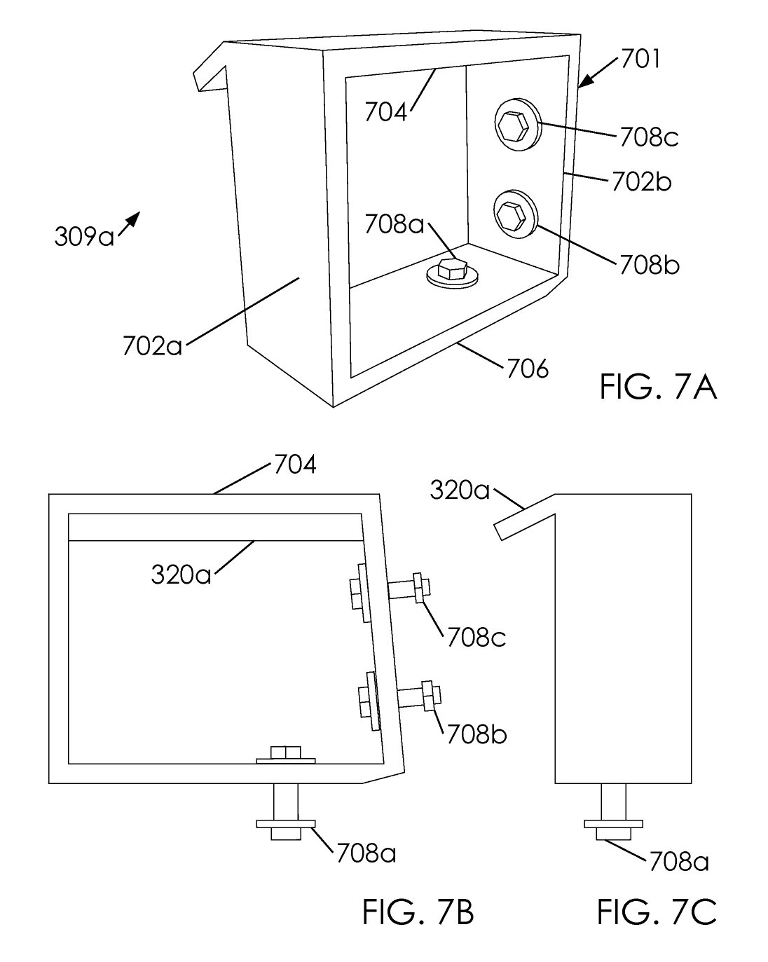

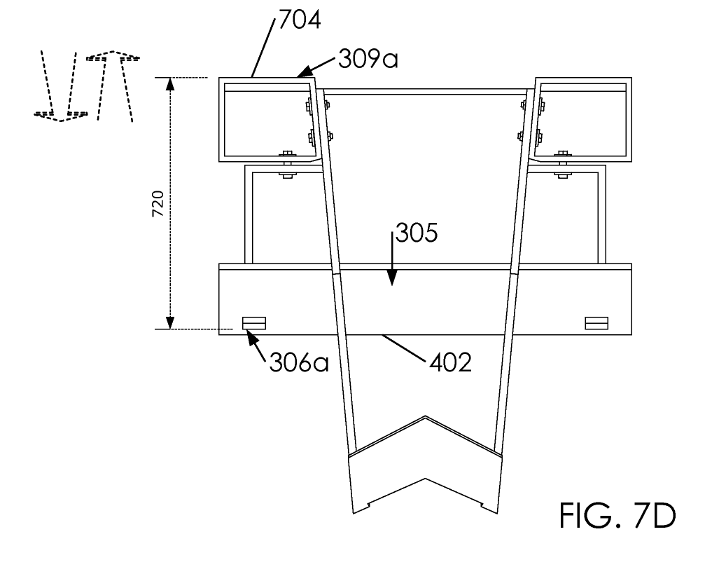

FIGS. 7A, 7B and 7C illustrate a perspective overview, an elevated front view and a perspective side view of said first adjustable box adapter 309a. The description of said first adjustable box adapter 309a can be extended to describe a mirror image description of said second adjustable box adapter 309b as would be obvious to one of the art and illustrated herewith. In one embodiment, said first adjustable box adapter 309a can comprise a body portion 701, said first lip support 320a and one or more screw assemblies. In one embodiment, said body portion 701 can comprise a first side 702a, a second side 702b, a top portion 704, a lower portion 706 and said first lip support 320a. In one embodiment, said one or more screw assemblies can comprise a first screw assembly 708a, a second screw assembly 708b and a third screw assembly 708c. In one embodiment, said body portion 701 can comprise an open cubical shape lacking a front portion and rear portion; wherein, said first side 702a, said second side 702b, said top portion 704 and said lower portion 706 make up the remaining parts of said cubical shape. In one embodiment, said top portion 704, said first side 702a and said lower portion 706 can be attached to one another with a right-angle at their joining points (as illustrated). However, in one embodiment, said second side 702b can be configured within said body portion 701 in a non-vertical arrangement; wherein, said second side 702b is not attached with a right angle to said top portion 704 and said lower portion 706. Thus, in one embodiment said second side 702b can match a non-vertical angle with said one or more vertical supports of said body portion 600 of said digging tool 100, as illustrated. In one embodiment, said first screw assembly 708a can attach to said third aperture 606a, said second screw assembly 708b can attach to said second aperture 604a, and said third screw assembly 708c can attach to said first aperture 602a. In one embodiment, said one or more adjustable box adapters can adjustably attach to said body portion 600 by adjusting a looseness of said one or more screw assemblies as between said body portion 600 and said one or more adjustable box adapters. In one embodiment, said first aperture 602a and said second aperture 604a can be taller than they are wide so that a fastener attached through them can be moved into various positions between an upper portion and a lower portion of said apertures.

FIG. 7D illustrates an elevated front view of said digging tool 100. In one embodiment, said digging tool 100 can comprise an adapter length 720 between said top portion 704 of said first adjustable box adapter 309a and said one or more apertures of said second horizontal support 305. In one embodiment, said adapter length 720 can selectively adjust by moving said one or more adjustable box adapters up and down relative to said body portion 600.

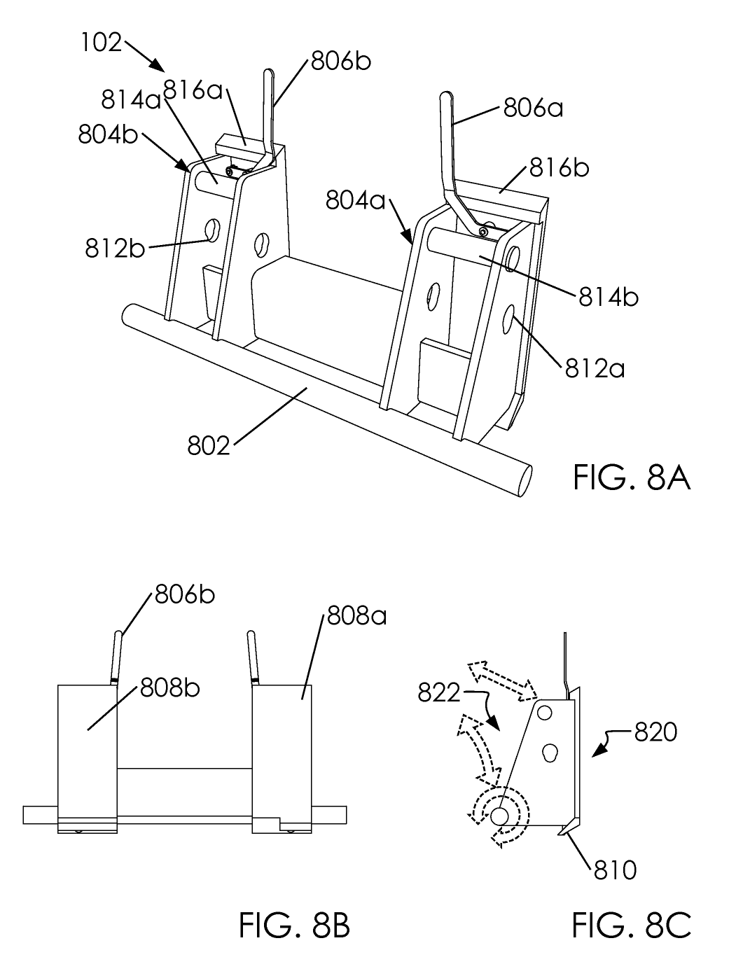

FIGS. 8A, 8B and 8C illustrate a perspective overview, an elevated front view and an elevated side view of said adapter 102. In one embodiment, said adapter 102 can comprise a horizontal bar 802, a one or more locking assemblies, a one or more handles, a one or more interface plates, a lower lip 810, a one or more side apertures and a one or more upper horizontal bars. In one embodiment, said one or more locking assemblies can comprise a first locking assembly 804a and a second locking assembly 804b. In one embodiment, said one or more handles can comprise a first handle 806a and a second handle 806b. In one embodiment, said one or more interface plates can comprise a first interface plate 808a and a second interface plate 808b. In one embodiment, said one or more side apertures can comprise a first side aperture 812a and a second side aperture 812b. In one embodiment, said one or more upper horizontal bars can comprise a first upper horizontal bar 814a and a second upper horizontal bar 814b. In one embodiment, said skid loader 106 can attach to said adapter 102 with said two arms at said horizontal bar 802 and with said one or more front loader arm lift cylinders at said one or more upper horizontal bars. Said adapter 102 can comprise a first side 820 and a second side 822. Thus, said skid loader 106 can act on said adapter 102 at two or more locations (as illustrated with FIG. 8C). In one embodiment, said skid loader 106 can lift and rotate said adapter 102 at said horizontal bar 802 and can push and pull said adapter 102 at said one or more upper horizontal bars. In one embodiment, said one or more front loader arm lift cylinders can be attached to said adapter 102 at said one or more side apertures rather than said one or more upper horizontal bars, as may be known in the art. In one embodiment, said one or more interface plates can each comprise an upper lip; for example, said first interface plate 808a can comprise a first upper lip 816a and said second interface plate 808b can comprise a second upper lip 816b.

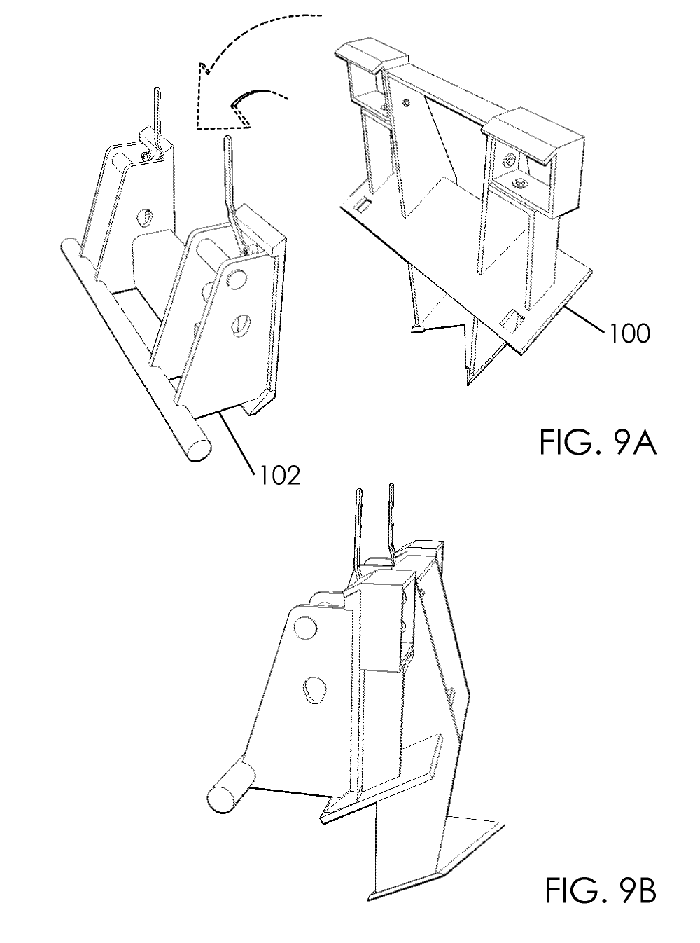

FIGS. 9A and 9B illustrate a perspective overview of said digging tool 100 attaching to said adapter 102 and attached to said adapter 102, respectively. In one embodiment, attaching said digging tool 100 to said adapter 102 can comprise: aligning and resting said one or more lip supports of said one or more adjustable box adapters with and on said upper lip of said one or more interface plates; adjusting said adapter length 720 of said digging tool 100 between said upper lip and said lower lip 810 of said adapter 102; and securing said one or more locking assemblies of said adapter 102 to said one or more apertures of said second horizontal support 305.

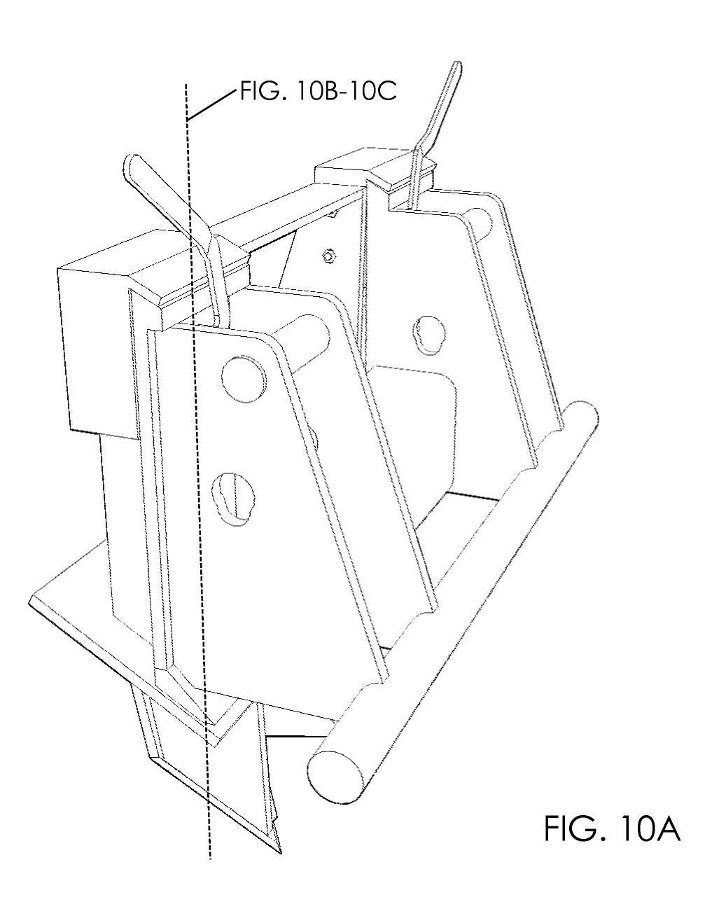

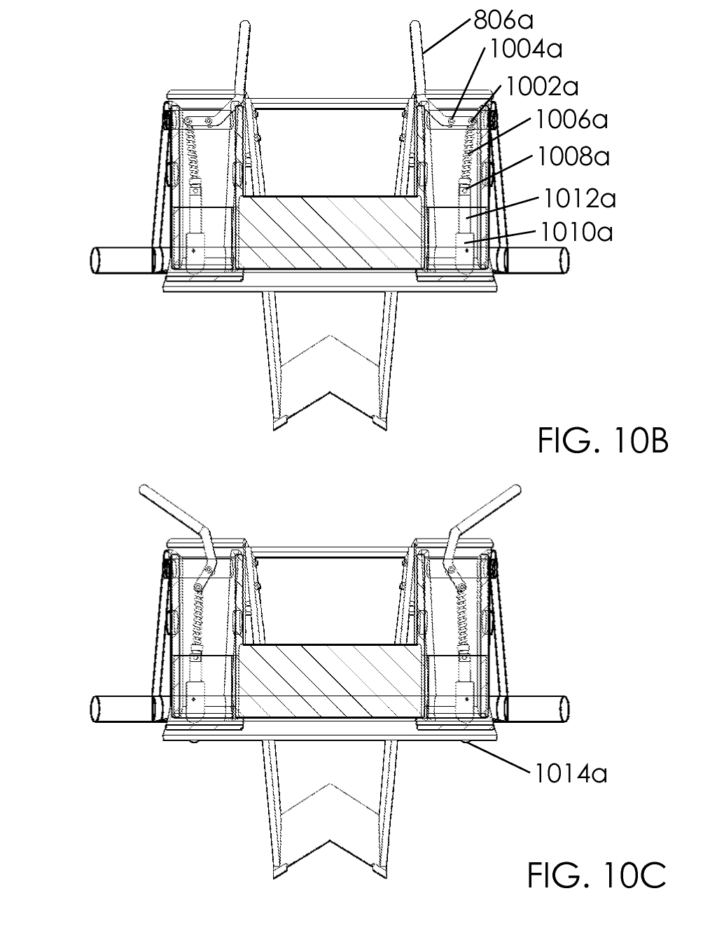

FIGS. 10A, 10B and 10C illustrate a front perspective overview and two elevated cross-section rear views of said digging tool 100 attached to said adapter 102. FIG. 10B illustrates said one or more locking assemblies in an unlocked configuration and FIG. 10C illustrates said one or more locking assemblies in a locked configuration. In one embodiment, securing said one or more locking assemblies of said adapter 102 to said one or more apertures of said second horizontal support 305 can comprise: aligning a portion of said one or more locking assemblies of said adapter 102 with said one or more apertures of said second horizontal support 305; and sliding a portion of said one or more locking assemblies through said one or more apertures. In one embodiment, said one or more locking assemblies can each comprise a one or more locking components capable of selectively locking a pin through said one or more apertures of said second horizontal support 305 of said digging tool 100. In one embodiment, said first locking assembly 804a can comprise said first handle 806a, a first pivot hinge 1002a, a first pivot hinge 1004a, a first spring 1006a, a first pivot hinge 1008a, a first socket 1010a, a first pin body 1012a, and a first pin head 1014a. In one embodiment, said second locking assembly 804b can comprise similar or identical components to said first locking assembly 804a, and in one case said second locking assembly 804b can be a mirror image to said first locking assembly 804a (as illustrated herein). In one embodiment, said first handle 806a can attach to said first pivot hinge 1002a and said first pivot hinge 1004a and can rotates on said first pivot hinge 1004a between an unlocked position (where said adapter 102 is in said unlocked configuration, see FIG. 10B) and a locked position (where said adapter 102 is in said locked configuration, see FIG. 10C). In one embodiment, said first handle 806a can attach to said first spring 1006a at said first pivot hinge 1002a. In one embodiment, said first spring 1006a can attach to a first pin body 1012a at said first pivot hinge 1008a. In one embodiment, said first pin body 1012a can slide through a first socket 1010a. In one embodiment, said first pin body 1012a can comprise said first pin head 1014a, which can remain inside of said first locking assembly 804a (where said adapter 102 is in said unlocked configuration, see FIG. 10B) and can extend out of said first locking assembly 804a (where said adapter 102 is in said locked configuration, see FIG. 10C).

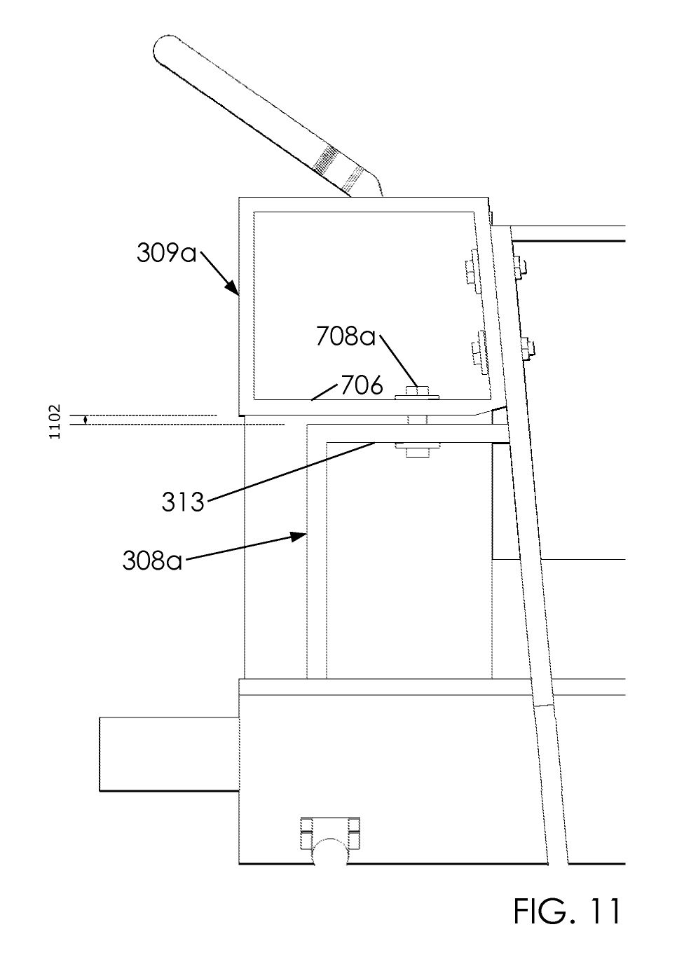

FIG. 11 illustrates an elevated front view of said digging tool 100 attached to said adapter 102 in said locked configuration. In one embodiment, securing said one or more locking assemblies of said adapter 102 to said one or more apertures of said second horizontal support 305 can further comprise: tightening said one or more screw assemblies between said one or more adjustable box adapters and said one or more outer supports; and holding said one or more lip supports of said one or more adjustable box adapters against said upper lips of said adapter 102. For example, in one embodiment, said first screw assembly 708a can be tightened to minimize a gap 1102 between said first adjustable box adapter 309a and said first outer support 308a, as illustrated.

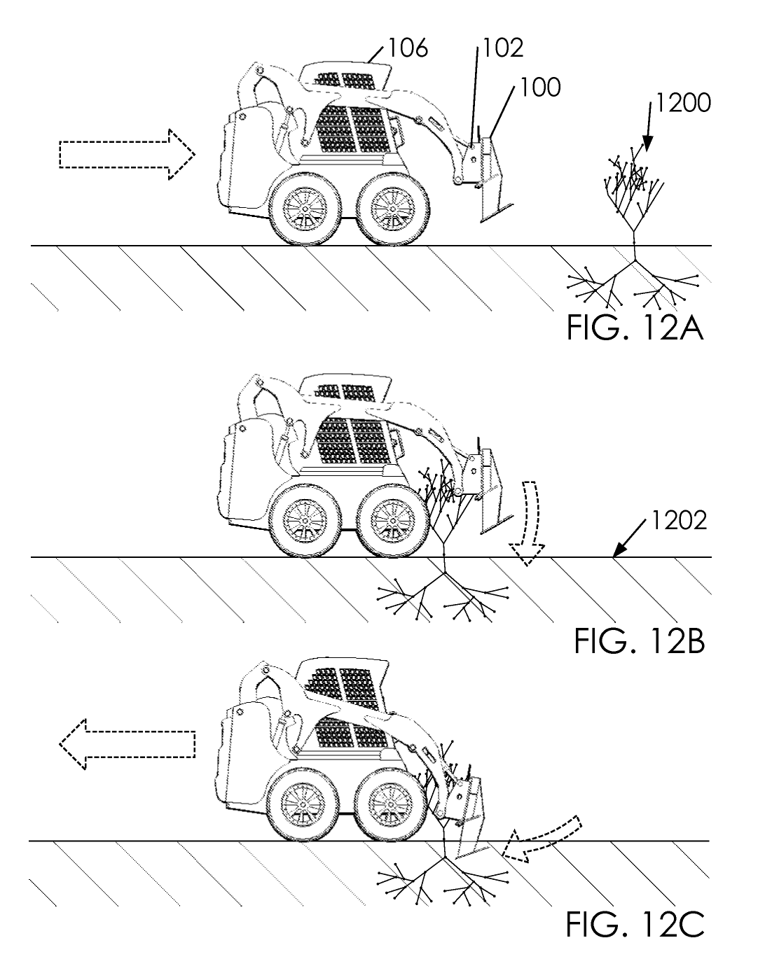

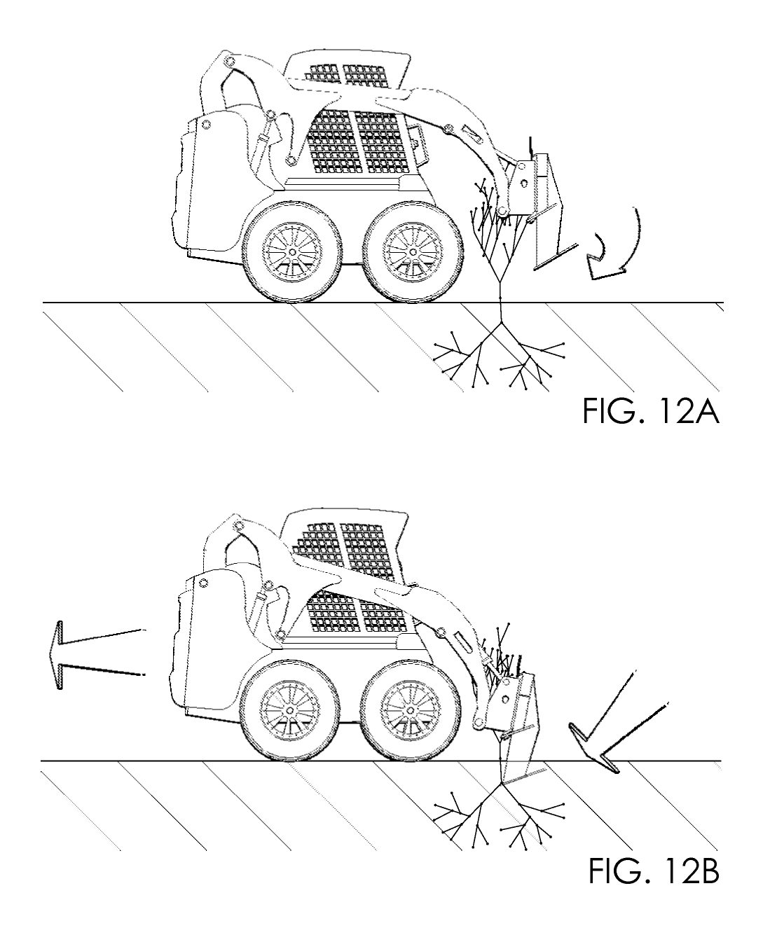

FIGS. 12A, 12B and 12C illustrate a perspective overview of said digging tool 100 digging up a plant 1200. FIG. 12A illustrates said skid loader 106 approaching said plant 1200. FIG. 12B illustrates said skid loader 106 lowering said digging tool 100 over said plant 1200. FIG. 12C illustrates said digging tool 100 digging up said plant 1200.

In one embodiment, removing said digging tool 100 from said skid loader 106 can comprise remotely releasing said one or more handles, pressing a portion of said blade 104 into the ground surface 1202, and driving said skid loader 106 backward so as to remove said digging tool 100 from said two arms and/or said adapter.

In one embodiment, grubbing a target object (such as said plant 1200) with said digging tool 100 can comprise: attaching said digging tool 100 to a vehicle (such as said skid loader 106); driving to said plant 1200; aligning said plant 1200 behind said digging tool 100; lowering said digging tool 100 into a ground surface 1202 near said plant 1200; pulling said digging tool 100 under said plant 1200 and below said ground surface 1202; and cutting a portion of said plant 1200 below said ground surface 1202.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein”.

1. A digging tool comprising:
a blade and a frame;
said frame attaches to a two arms of an articulating arm utility vehicle;
said blade comprises a top side, a bottom side, a first side edge, a second side edge, a back side having a point, a front side having a v-cut portion;
said blade is mounted on said frame and used as a digging tool with said v-cut portion by:
pressing said blade with said v-cut portion into a ground surface,
grabbing a portion of a target object beneath said ground surface with said v-cut portion,
pulling a portion of said target object above said ground surface.

2. The digging tool of claim 1 further comprising:
said frame comprises a one or more horizontal supports, a one or more vertical supports (comprising a first vertical support and a second vertical support), a front side, and a back side;
said blade attaches between a lower portion of said one or more vertical supports; and
a first horizontal support attaches been an upper portion of said one or more vertical supports.

3. The digging tool of claim 1 further comprising:
an adapter having a first side and a second side;
said adapter can attach said two arms of said articulating arm utility vehicle; and
said digging tool to said articulating arm utility vehicle.

4. The digging tool of claim 3 further comprising:
said frame comprises a one or more horizontal supports, a one or more vertical supports (comprising a first vertical support and a second vertical support), a front side, and a back side;
said blade attaches between a lower portion of said one or more vertical supports;
a first horizontal support attaches been an upper portion of said one or more vertical supports; and
a second horizontal support attaching between said one or more vertical supports and substantially half way between said first horizontal support an said blade.

5. The digging tool of claim 4 wherein said frame further comprises:
a one or more adjustable box adapters (comprising a first adjustable box adapter and a second adjustable box adapter);
said first horizontal support is attached between said one or more adjustable box adapters;
said one or more adjustable box adapters are proximate to said upper portion;
said one or more adjustable box adapters releaseably attach to said frame;
said second horizontal support comprises a one or more pin apertures;
said one or more adjustable box adapters each comprise one of a one or more lip supports;
said one or more lip supports and said one or more pin apertures are separated by an attaching distance;
said attaching distance can be expanded or contracted by adjustably attaching said one or more adjustable box adapters to said frame;

6. The digging tool of claim 6 wherein:
releaseably attaching said one or more adjustable box adapters to said frame 101 comprises:
attaching a portion of said one or more adjustable box adapters to a one or more outer supports, each having a substantially horizontal portion, with a first screw assembly,
attaching a portion of said one or more adjustable box adapters to one among said one or more vertical supports with a second screw assembly, and
adjustably tightening said first screw assembly according to a desired distance on said attaching distance.

7. The digging tool of claim 4 further comprising:
said frame comprise a one or more lip supports and a one or more handles;
said one or more lip supports releaseably attach to a portion of said two arms of said articulating arm utility vehicle; and
said one or more handles releaseably lock said frame to said two arms of said articulating arm utility vehicle.

8. The digging tool of claim 4 further comprising:
said second horizontal support is attached to said one or more vertical supports at a first angle relative to a horizontal plane;
said blade is attached to said lower portion of said one or more vertical supports at a second angle relative to said horizontal plane; and
said first angle and said second angle are each about forty five degrees.

9. The digging tool of claim 1 further comprising:
said articulating arm utility vehicle comprises a skid loader.

10. The digging tool of claim 1 further comprising:
said articulating arm utility vehicle comprises a backhoe.

11. The digging tool of claim 1 further comprising:
said v-cut portion of said blade comprises a plurality of bevels comprising a first interior rear bevel, a second interior rear bevel, a first exterior rear bevel nearest said first side edge, and a second exterior rear bevel nearest to said second side edge; and
said plurality of bevels are designed to dig through portions of said ground surface.

12. The digging tool of claim 1 further comprising:
said point of said blade comprises a one or more front bevels designed to dig through a portion of said ground surface.

13. The digging tool of claim 1 further comprising:
an adapter comprising a horizontal bar, a one or more locking assemblies, a one or more handles, a one or more interface plates, a lower lip, a one or more side apertures and a one or more upper horizontal bars; and
said adapter can releaseably attach to said frame on a first side and to said two arms of said articulating arm utility vehicle on a second side.

14. The digging tool of claim 13 further comprising:
said frame can be releaseably locked to said adapter by:
aligning and attaching said one or more lip supports with said one or more upper horizontal bars;
rotating said frame against said; and
locking said one or more handles.
